(19) United States
(12) Patent Application Publication
(10) Pub. No.: US 2022/0229952 A1
(43) Pub. Date: Jul. 21, 2022

(54) INFORMATION PROCESSING APPARATUS, INFORMATION PROCESSING METHOD, AND STORAGE MEDIUM

(71) Applicant: FUJITSU LIMITED, Kawasaki-shi (JP)

(72) Inventors: Makiko Konoshima, Kawasaki (JP); Hirotaka Tamura, Yokohama (JP)

(73) Assignee: FUJITSU LIMITED, Kawasaki-shi (JP)

(21) Appl. No.: 17/511,624

(22) Filed: Oct. 27, 2021

(30) Foreign Application Priority Data
Jan. 15, 2021 (JP) 2021-005349

(51) Int. Cl. G06F 30/20

(52) U.S. Cl. CPC G06F 30/20; G06F 2119/02

(57) ABSTRACT

An information processing apparatus includes one or more memories; and one or more processors coupled to the one or more memories and the one or more processors configured to decompose a first matrix of a coupling coefficient which represents interaction between a plurality of variables into a plurality of matrices by using a rank number, obtain, from the plurality of matrices, a second element that corresponds to a first element of the coupling coefficient, and restore the first element based on the second element.

### CROSS-REFERENCE TO RELATED APPLICATION

This application is based upon and claims the benefit of priority of the prior Japanese Patent Application No. 2021-5349, filed on Jan. 15, 2021, the entire contents of which are incorporated herein by reference.

### FIELD

The embodiment discussed herein is related to an information processing apparatus, an information processing method, and a storage medium.

### BACKGROUND

An optimization process is a field of information processing and an important field. Optimization problems are roughly classified into a linear programming problem and a discrete optimization problem. When the scale of the latter increases, the number of combinations in the problem explosively increases, and the calculation time does not fall within a realistic range with a technique of obtaining by calculating all the combinations in a brute-force manner.

There is an Ising apparatus (also referred to as, for example, a Boltzmann machine) that performs simulated annealing using an Ising-type energy function as a method of solving such a large-scale discrete optimization problem. For the Ising apparatus, there is a calculation technique in which a problem to be calculated is replaced with an Ising model that is a model representing the behavior of a spin of a magnetic body and represented by a quadratic.

Japanese Laid-open Patent Publication No. 2019-185602, U.S. Patent Application Publication No. 2019/0318258, and Japanese Laid-open Patent Publication No. 2018-206016 are disclosed as related art.

### SUMMARY

According to an aspect of the embodiments, an information processing apparatus includes one or more memories; and one or more processors coupled to the one or more memories and the one or more processors configured to decompose a first matrix of a coupling coefficient which represents interaction between a plurality of variables into a plurality of matrices by using a rank number, obtain, from the plurality of matrices, a second element that corresponds to a first element of the coupling coefficient, and restore the first element based on the second element.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a functional block diagram of an information processing apparatus according to one embodiment;

FIG. 2 illustrates a system configuration example according to the one embodiment;

FIG. 3 illustrates an example of a functional block diagram of the information processing apparatus according to an embodiment;

FIG. 4 explains matrix decomposition;

FIG. 5 illustrates a system configuration example according to the present embodiment;

FIG. 6 is a flowchart illustrating a flow of the entirety of a minimum solution searching process according to the present embodiment;

FIG. 7 illustrates an example of a matrix of the distance between cities;

FIG. 8 illustrates an example of a bit allocation for cities to visit;

FIG. 9 is a flowchart illustrating a flow of a matrix decomposition and restoration process according to the present embodiment;

FIG. 10 is a flowchart illustrating a flow of the minimum solution searching process according to the present embodiment;

FIG. 11 illustrates examples of results of the minimum solution searching process according to the present embodiment;

FIG. 12 illustrates an example of the difference in memory allocation amount depending on whether compression is performed according to the present embodiment; and

FIG. 13 explains a hardware configuration example.

### DESCRIPTION OF EMBODIMENTS

In the Ising model, a plurality of variables are respectively regarded as a plurality of spins of a magnetic body, and the simulated annealing is performed by using values of a coupling coefficient that represent the strength of mutual coupling of the plurality of spins. When the number of variables included in the energy function represented by the Ising model increases, the number of coupling variables also increases. Thus, for example, when solving a problem in which the number of bits of x is very large in the Ising model or the like in a problem of obtaining x with which an energy function E (x) is minimized, allocating a matrix that includes all of the values of the coupling coefficient of the Ising model in a memory of an apparatus or software may make the size of data to be allocated in the memory become tens of gigabytes, or in some cases, hundreds of gigabytes or larger.

Accordingly, the following problems arise: preparation of a large memory becomes difficult depending on a platform that performs processing; and overhead for allocation to the memory increases.

In one aspect, an object is to provide an information processing apparatus, a method of processing information, and an information processing program that may suppress the size of data to be allocated in a memory when a discrete optimization problem is solved.

In the one aspect, the size of the data to be allocated in the memory when a discrete optimization problem is solved may be suppressed.

Hereinafter, examples of an information processing apparatus, a method of processing information, and an information processing program according to an embodiment will be described in detail with reference to the drawings. The examples do not limit the present embodiment. The examples may be combined with each other as appropriate to the degree with which no inconsistency is caused. The disclosure herein is not limited to the case where an optimization problem is solved by using an Ising model. The disclosure herein may also be applied to the case where an optimization problem is solved by using a model including third-degree or higher-degree terms.

First, an example of a minimum solution searching process is described. In a problem of obtaining a vector x€{0, 1}N or x€{1, 1}N that minimizes an energy function E(x), for example, in the case of an Ising model (second degree), the energy function E(x) is calculated by the following expression (1).

$$E ( x ) = {\sum }_{i , j = 1}^{N} {W}_{i , j} {x}_{i} {x}_{j} + {\sum }_{i = 1}^{N} {b}_{i} {x}_{i} + C \qquad ( 1 )$$

In expression (1), W is a matrix. To calculate E(x), N² elements are allocated as they are in memory for calculation. For this reason, for example, when N=100000 and W is a real number (4 bytes), 40 gigabytes are demanded. Since b is one-dimensional and C is scalar, it is not demanded to consider the problem of a memory allocation amount.

In the case of, for example, the third degree instead of the second degree, the energy function E(x) is calculated by expression (2) below.

$$E ( x ) = {\sum }_{i , j , k = 1}^{N} {Z}_{i , j , k} {x}_{i} {x}_{j} {x}_{k} + {\sum }_{i , j = 1}^{N} {W}_{i , j} {x}_{i} {x}_{j} + {\sum }_{i = 1}^{N} {b}_{i} {x}_{i} + C \qquad ( 2 )$$

In the case of expression (2), Z is a third-degree array, and, for example, even when N=10000, 400 gigabytes are demanded.

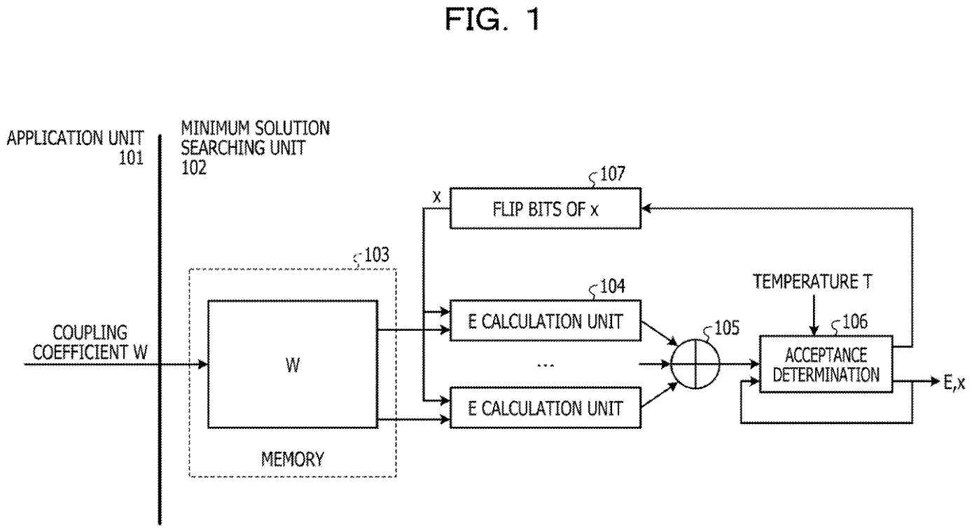

FIG. 1 illustrates an example of a functional block diagram of the information processing apparatus according to one embodiment. As illustrated in FIG. 1, a coupling coefficient W designated by an application unit 101 is transferred as it is to a memory 103 of a minimum solution searching unit 102.

An energy calculation unit 104 may include a plurality of calculation units so as to be parallelized by partially using W. As an example, an energy calculation unit 104 calculates Wᵢ₀ⱼ₀xᵢ₀xⱼ₀ for (i0, j0) which is a certain set of i and j in expression (1). A process in which a plurality of sets of i and j are calculated and added together may be performed.

Next, calculation results by the calculation units of the energy calculation unit 104 are added together by a unit 105 to complete the process of expression (1). In the case where a unit 106 performs determination based on the Metropolis criterion, acceptance determination is performed also by referring to a temperature T, flipping is performed on several bits from 1 by using x of the determination result, and the process is performed again in the energy calculation unit 104. The flipping changes a value from 1 to 0 or 0 to 1 in the case of xϵ{0, 1}^{N}, and from 1 to −1 or −1 to 1 in the case of xϵ{1, −1}^{N}.

The processing performed by the energy calculation unit 104 to a unit 107 ends when a predetermined number of times is reached or a desired energy E is obtained. The calculation of energy E may be calculation of the difference in energy. In this case, the configuration is substantially unchanged from the configuration illustrated in FIG. 1. In the case of the calculation of the energy difference, the unit 107 outputs a bit difference Δx obtained when the bit flip is performed, the energy calculation unit 104 calculate energy differences, the unit 105 adds the energy differences together, and the unit 106 performs the acceptance determination.

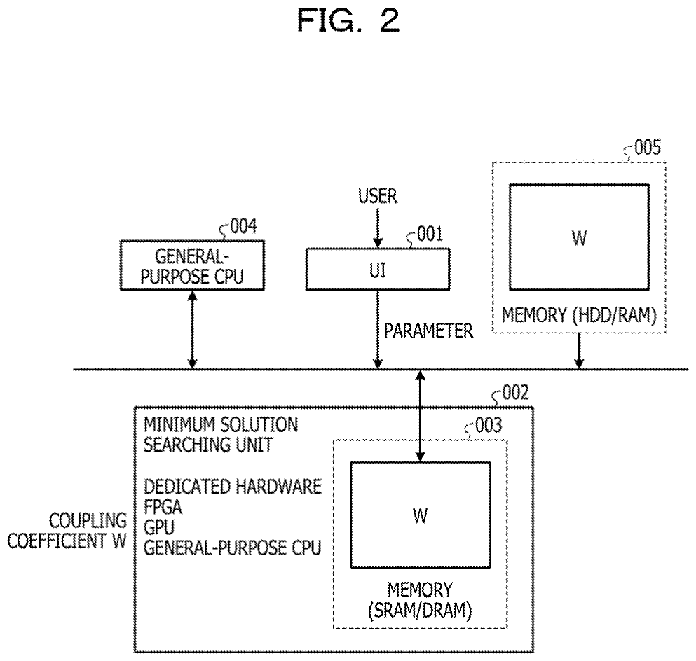

FIG. 2 illustrates a system configuration example according to the one embodiment. Parameters given from the outside such as a coupling coefficient W and a temperature are input by a user through the user interface (UI) 001. The coupling coefficient W input through the UI 001 is stored in a memory 005, which is, for example, a hard disk drive (HDD) or a random-access memory (RAM). The coupling coefficient W stored in the memory 005 is input to a memory 003.

The minimum solution searching unit 002 corresponds to the minimum solution searching unit 102 that is illustrated in FIG. 1 and includes the energy calculation unit 104 to the unit 107. The memory 003 corresponds to the memory 103 illustrated in FIG. 1 and is a static RAM (SRAM) or a dynamic RAM (DRAM) serving as a memory for a dedicated hardware device, a field-programmable gate array (FPGA), a graphics processing unit (GPU), and a general-purpose central processing unit (CPU) of the minimum solution searching unit 002. The general-purpose CPU 004 is a general-purpose CPU that handles applications and the like for processes for the UI 001 and the minimum solution searching unit 002.

Next, the present embodiment is described. According to the present embodiment, the coupling coefficient is compressed by a method that does not use complex calculation for decompression. Here, the complex calculation refers to, for example, the method according to the disclosure described in Japanese Laid-open Patent Publication No. 2018-206016. According to this method, the difference from a temporally and spatially neighboring numerical value is taken, and compression is performed with reference to a table. In order to decompress the compressed data, the table is referred to obtain the difference value, and further, the neighboring numerical value is referred to restore the original value. However, according to this method, it is demanded that a table is separately prepared and referred to one by one to generate variable length data having different numbers of bits and restore the original data from the variable length data. In addition, the decompressed neighboring numerical value is referred to. Thus, this method is unsuitable for parallel processing.

In contrast, according to the present embodiment, the positions of the elements of a matrix U and a matrix V corresponding to the elements of the coupling coefficient W desired to be restored are uniquely determined without referring to surroundings, and W is obtainable only by the product-sum operation. Thus, it may be said that parallel processing is possible and the calculation is simple.

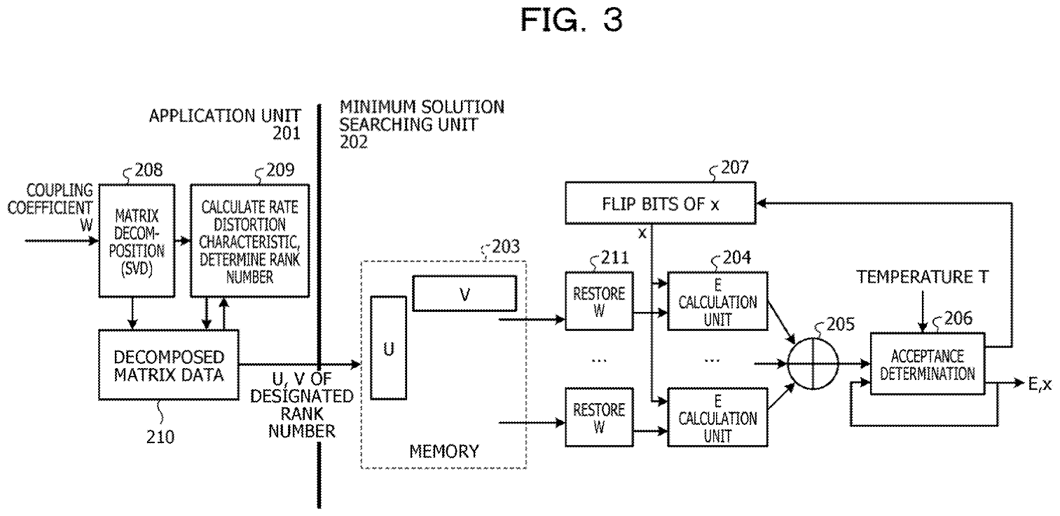

FIG. 3 illustrates an example of a functional block diagram of an information processing apparatus 10 according to the present embodiment. As illustrated in FIG. 3, for example, low-rank approximation of a singular value decomposition (SVD) is used to compress the coupling coefficient W. The SVD is used to decompose the coupling coefficient W into three matrices represented as W=U*S*V. The matrix U is N×k, the matrix S is k×k, and the matrix V is k×N. Low-rank approximation may be performed by decreasing the magnitude of a rank number k. The matrix S is a diagonal matrix representing a singular value and is multiplied by the matrix U or the matrix V to obtain two matrices.

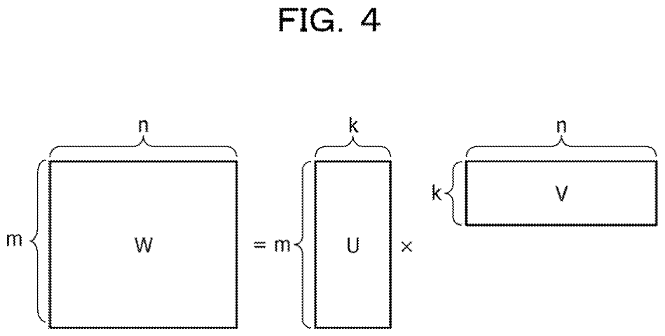

FIG. 4 explains matrix decomposition. As illustrated in FIG. 4, a matrix W of n×m is decomposed into a coefficient matrix U of k×m and a basis matrix V of n×k by using the rank number k. The rank number k is a number designated in advance by the user.

The matrix decomposition technique is not limited to the SVD and may be, for example, nonnegative matrix factorization in which a matrix after decomposition is limited to nonnegative values or 01 matrix factorization in which a matrix after decomposition is limited to be binary. The selection of the matrix decomposition technique depends on how the coupling coefficient W of the problem to be solved is desired to be handled.

Referring back to the description of FIG. 3, the coupling coefficient W is subjected to matrix decomposition in a matrix decomposition unit 208. The matrix decomposition is performed by using a plurality of designated rank numbers k, and the results are accumulated in a unit 210.

A unit 209 calculates, as a rate distortion characteristic, the relationship between an error compared to W and the rank number k when the matrices U and V, or U, V, and S resulting from the matrix decomposition are recomposed. For example, when the matrix recomposed by using the matrices U and V having been restored after the decomposition into the matrices U and V is W′=UV, an error may be generated between the coupling coefficient W and W′. Here, a difference D between the coupling coefficient W and W′ is referred to as distortion, and the difference D is able to be calculated by the following expression: D=Σᵢⱼ(Wᵢⱼ−W′ᵢⱼ)².

As the magnitude of the rank number k decreases, the numbers of elements of the matrices U and V decrease and the magnitude of the difference D increases. Accordingly, the minimum rank number k for the allowable difference D and the matrices U and V, or U, V, and S obtained with this k are selected by changing the rank number k and checking the difference D with some values. In the example illustrated in FIG. 3, it is assumed that the matrices U and V have been selected.

The selected matrices U and V are accumulated in a memory 203, only the elements of the matrices U and V corresponding to the elements of the coupling coefficient W to be used for calculation in an energy calculation unit 204 are obtained from the memory 203 by a coupling coefficient W restoration unit 211, and the elements of the coupling coefficient W are restored. Depending on properties of the coupling coefficient W or the problem, positions that become diagonal components of the coupling coefficient W may be 0 and only a region that becomes an upper triangular matrix or a lower triangular matrix may be referred to and treated as a symmetric matrix.

The energy calculation unit 204 calculates the energy or the energy difference by using the elements of the coupling coefficient W restored by the coupling coefficient W restoration unit 211. Even when the coupling coefficient W is of the third or higher degree, processes may be performed with a configuration similar to the configuration illustrated in FIG. 3 by using tensor decomposition such as Tucker decomposition.

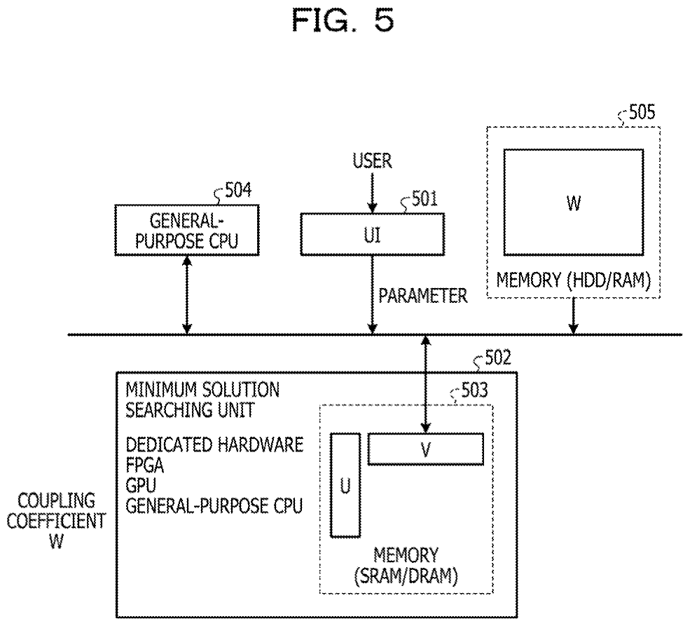

FIG. 5 illustrates a system configuration example according to the present embodiment. Parameters given from the outside such as a coupling coefficient W and a temperature are input by the user through a UI 501. The coupling coefficient W input through the UI 501 is stored in a memory 505, which is, for example, an HDD or a RAM.

The coupling coefficient W stored in the memory 505 is compressed by a general-purpose CPU 504 to calculate the matrices U and V, and the matrices U and V are stored in a memory 503. The general-purpose CPU 504 is a general-purpose CPU that handles applications and the like for processes for the UI 501 and a minimum solution searching unit 502. In addition, the general-purpose CPU 504 performs processes for the matrix decomposition unit 208 and the units 209 and 210 illustrated in FIG. 3.

The minimum solution searching unit 502 corresponds to the minimum solution searching unit 202 that is illustrated in FIG. 3 and includes the energy calculation unit 204 to the unit 207. The memory 503 corresponds to the memory 203 illustrated in FIG. 3 and is an SRAM or a DRAM serving as a memory for a dedicated hardware device, an FPGA, a GPU, and a general-purpose CPU of the minimum solution searching unit 502.

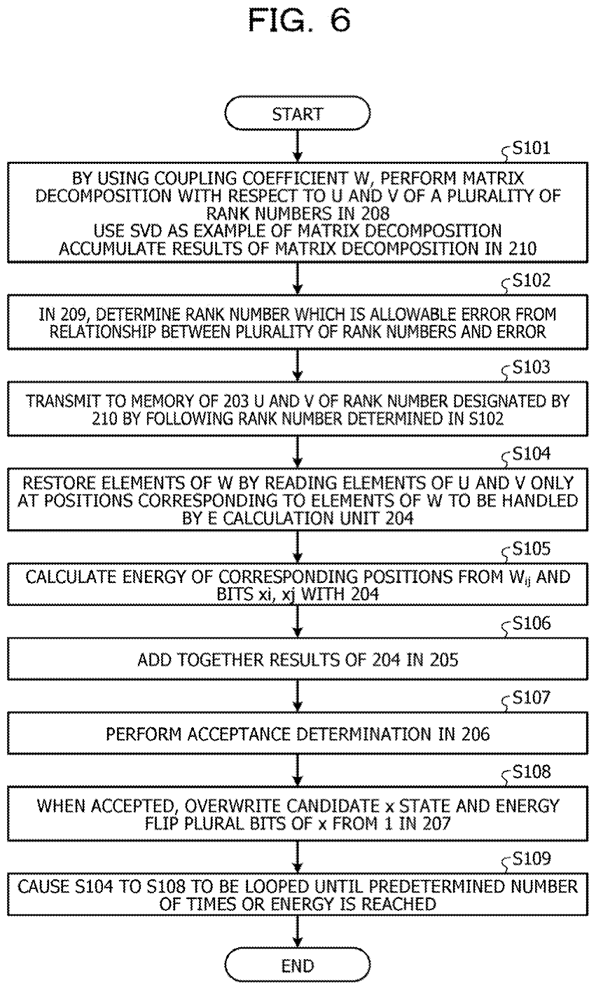

Next, with reference to a flowchart illustrated in FIG. 6, the minimum solution searching process to be executed by the information processing apparatus 10 according to the present embodiment is described along a flow. FIG. 6 is a flowchart illustrating a flow of the entirety of the minimum solution searching process according to the present embodiment.

As illustrated in FIG. 6, the information processing apparatus 10 performs, by using the coupling coefficient W, matrix decomposition with respect to the matrices U and V obtained with a plurality of rank numbers k in the matrix decomposition unit 208. Although the SVD is used as an example of the matrix decomposition, 01 matrix factorization or the like may be used according to the conditions of W. The results of the matrix decomposition are accumulated in the unit 210 (step S101).

Next, the information processing apparatus 10 checks and determines the rank number k for an allowable error from the relationships between the plurality of rank numbers k and the error D in the unit 209 (step S102).

Next, the information processing apparatus 10 transfers to the memory 203 the matrices U and V for which the rank number k has been obtained in step S102 (step S103).

Next, the information processing apparatus 10 restores the elements of the coupling coefficient W by reading the elements of the matrices U and V only at positions corresponding to the elements of the coupling coefficient W to be handled by the energy calculation unit 204 (step S104).

Next, the information processing apparatus 10 calculates the energy of the corresponding positions from Wᵢⱼ and the bits xᵢ, xⱼ in the energy calculation unit 204 (step S105).

Next, the information processing apparatus 10 obtains the entire energy by adding together the results of step S105 in the unit 205 (step S106).

Next, the information processing apparatus 10 performs the acceptance determination based on the Metropolis criterion or the like in the unit 206 (step S107).

Next, when accepted in step S107, the information processing apparatus 10 overwrites a candidate x state and the energy to reflect the acceptance determination result in step S107 and flips the bits of x for the next processing (step S108).

Next, the information processing apparatus 10 causes steps S104 to S108 to be looped until a predetermined number of times or energy is reached (step S109).

Next, by using, a traveling salesman problem, the minimum solution searching process to be executed by the information processing apparatus 10 according to the present embodiment is more specifically described. The traveling salesman problem includes cities and visiting routes. For example, when the number of cities is represented as c, the number of bits is cities×routes or c².

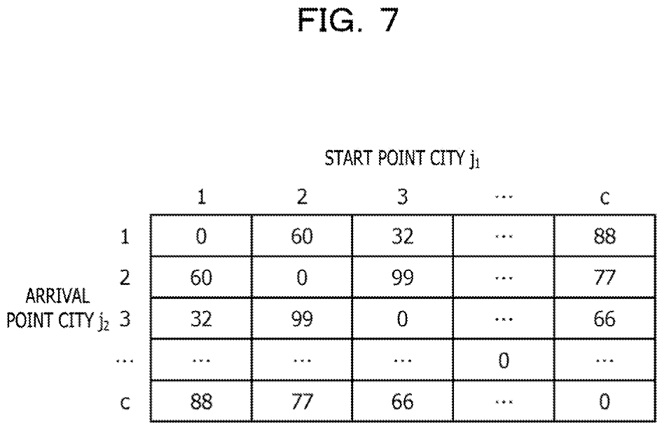

FIG. 7 illustrates an example of a matrix of the distance between cities. In the traveling salesman problem, the coupling coefficient W is a matrix representing the distance between cities in which the rows and the columns are cities. This matrix is a symmetric matrix having the diagonal components of 0 because the diagonal components are the distance between the same cities. In FIG. 7, the unit of numerical values representing the distance between cities such as “60” may be represented not only by the distance such as “cm (centimeters)” but also by a time period such as “minutes”.

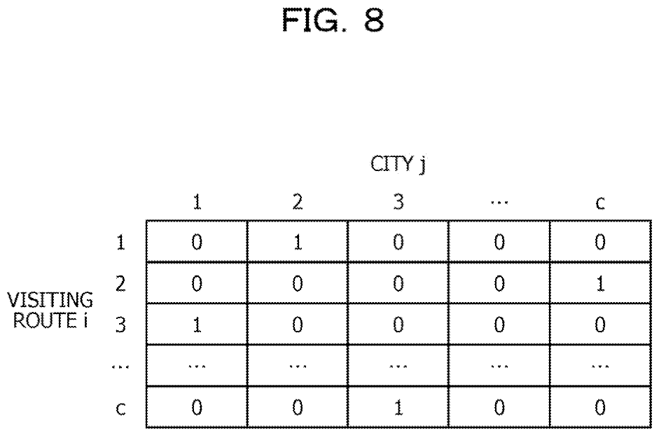

FIG. 8 illustrates an example of a bit allocation for cities to visit. For example, when the city to visit first is a city 2, as illustrated in FIG. 8, a bit of 1 is set for the city to visit in the row of the visiting route, and 0 is set for all the other cities. For example, only one of the bits is set to 1 in each of the rows and each of the columns. In such a traveling salesman problem, the energy function is represented by expression (3) below.

$$E ( x ) = {\sum }_{{j}_{1} , {j}_{2} i = 1}^{C} {W}_{{j}_{1} , {j}_{2}} {x}_{i , {j}_{1}} {x}_{( x + 1 ) , {j}_{2}} + {λ}_{1} {\sum }_{b = 1}^{C} {( {\sum }_{a = 1}^{C} {x}_{a , b} - 1 )}^{2} + {λ}_{2} {\sum }_{b = 1}^{C} {( {\sum }_{a = 1}^{C} {x}_{a , b} - 1 )}^{2} \qquad ( 3 )$$

In expression (3), the first term on the right side is a total distance based on x, where the visiting route i=c+1 is set as i=1 (set as a closed path). The second and third terms on the right side represent constraints on the rows and the columns, and A represents the magnitudes of the constraints. To represent the traveling salesman problem by using the Ising model, it is sufficient that x in expression (1) be expanded into a vector, and the coupling coefficient W be expanded as the x is expanded. However, description will be made by using expression (3) here. The constraints in and after the second term on the right side of expression (3) will be omitted in the following description. Here, the flowchart of the minimum solution searching process illustrated in FIG. 6 will be more specifically described based on the first term on the right side of (3).

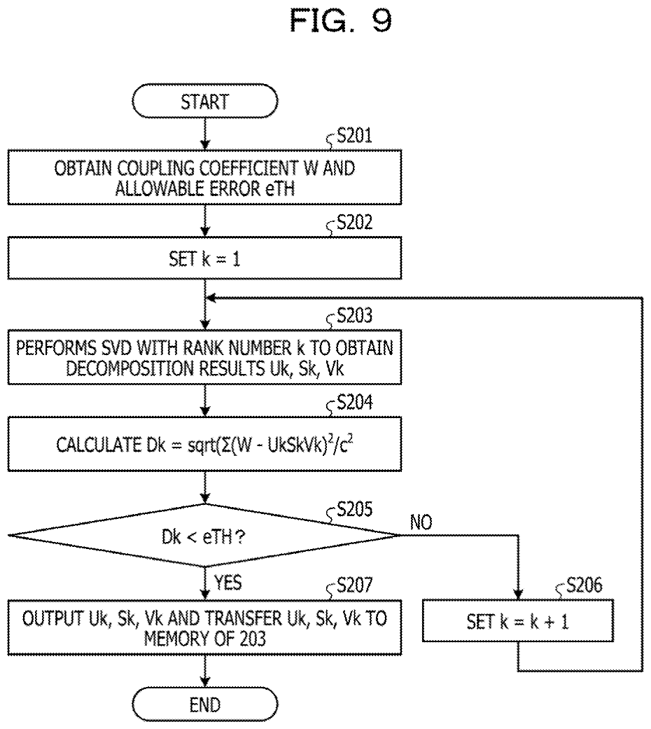

First, steps S101 to S103 in the flowchart illustrated in FIG. 6 are described with reference to a flowchart illustrated in FIG. 9. FIG. 9 is a flowchart illustrating a flow of a matrix decomposition and restoration process according to the present embodiment.

As illustrated in FIG. 9, the information processing apparatus 10 first obtains the coupling coefficient W and an allowable error eTH from the memory 505 (step S201). The allowable error eTH is designated by, for example, the user through the UI. Since the coupling coefficient W is a distance matrix, the allowable error eTH is an allowable value of deviation of the distance between cities. One of examples of allowable error eTH, the allowable error eTH is 100 when the numerical values of the elements of the coupling coefficient W is allowed to deviate by up to 100 cm in cm.

Next, the information processing apparatus 10 sets, for example, an initial value of a rank number k to 1 (step S202). Thereafter, the processing is repeated while incrementing the rank number k until the difference D between the coupling coefficient W and the restored matrix W′ reaches the predetermined allowable error eTH. For example, the minimum rank number k within the allowable error eTH is searched.

Next, the information processing apparatus 10 performs the SVD with the rank number k to obtain matrices Uk, Sk, and Vk as the results of the decomposition (step S203).

Next, the information processing apparatus 10 calculates a squared error Dk=sqrt(Σ(W−UkSkVk)²)/c² indicating the difference between the coupling coefficient W and the restored matrix W′ to calculate Dk (step S204).

Next, the information processing apparatus 10 determines whether the squared error Dk calculated in step S204 is smaller than the allowable error eTH (step S205). When it is determined that the squared error Dk is not smaller than the allowable error eTH (step S205: No), the information processing apparatus 10 increments the rank number k (step S206) and repeats the processing from step S203.

In contrast, when it is determined that the squared error Dk is smaller than the allowable error eTH (step S205: Yes), the information processing apparatus 10 outputs Uk, Sk (diagonal components), and Vk and transfers them to the memory 503 (step S207). After the execution of step S207, the matrix decomposition and restoration process illustrated in FIG. 9 ends.

The matrix decomposition and restoration process illustrated in FIG. 9 may be executed with modification as follows.

For example, in step S203, instead of the SVD, nonnegative matrix factorization or 0/1 matrix decomposition in which element values undergo dyadic expansion is performed. In step S204, an absolute value error is used instead of the squared error.

Although the initial value of the rank number k is set to 1 in step S202, the processing is started with k=c/2 as the initial value and repeated with k is set so that k=k−1 in step S206. In this case, in step S205, it is determined whether the squared error Dk is larger than the allowable error eTH (whether Dk>eTH is true).

In step S205, the rank number k is set to k=1 to c/2 with which the compression ratio is lower than 1 or in a range with which the compression ratio is a predetermined compression ratio. When, in step S205, a certain rank number k is detected near a point where a decrease in the magnitude of the error stops, the repetitive processing ends and the processing proceeds to step S207. Such detection of the rank number k is performed by using, for example, an expression Dₖ₋₁−Dₖ>Dₖ Dₖ₊₁ ε, where a constant ε is an error in a floating-point number.

In step S206, when, in addition to Uk, Sk, and Vk, error values of the upper or lower triangular matrix other than the diagonal components are output for an error g=W−UkSkVk, a certain number of error values counted from the largest error are output in sets of an element position and an error value (for example, as [row number, column number, error value] or the like). In step S206, Sk and Uk or Vk are multiplied to output two matrices.

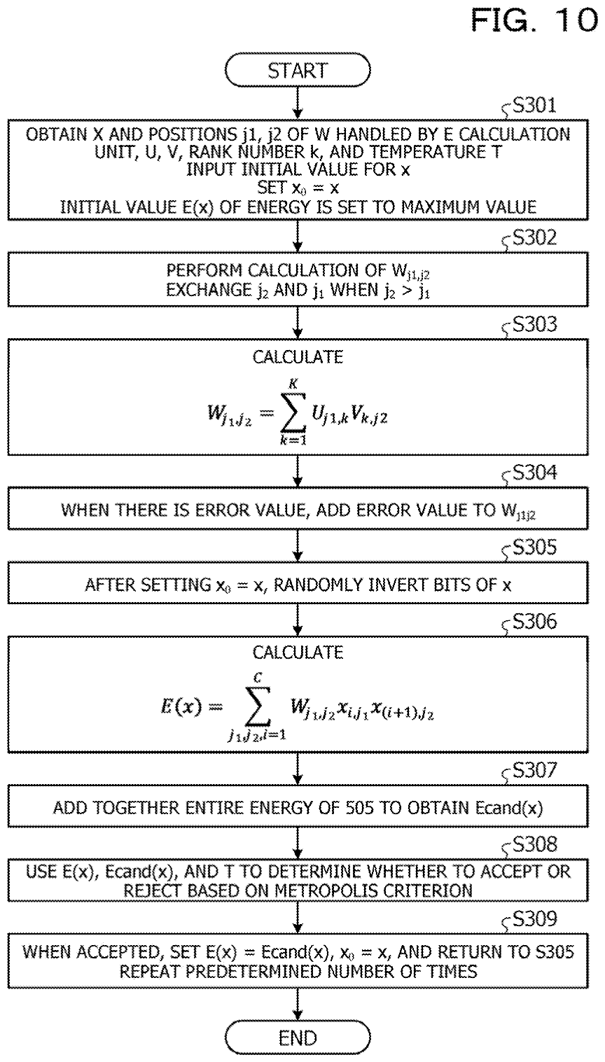

Next, remaining steps S104 to S109 in the flowchart illustrated in FIG. 6 are described with reference to a flowchart illustrated in FIG. 10. FIG. 10 is a flowchart illustrating a flow of the minimum solution searching process according to the present embodiment. The minimum solution searching process illustrated in FIG. 10 is described on the assumption that the matrix decomposition and restoration process illustrated in FIG. 9 has been executed by using the traveling salesman problem as an example, and the coupling coefficient W has been decomposed into two matrices U and V. In the minimum solution searching process illustrated in FIG. 10, the unit of the energy calculation unit 204 is the j₁, j₂ unit in expression (3).

As illustrated in FIG. 10, first, the information processing apparatus 10 obtains initial values for x and positions j₁, j₂, of the coupling coefficient W handled by the energy calculation unit 204, U, V, the rank number k, and a temperature Tx (step S301). Here, x is set to x₀=x by randomly inputting the initial value. An initial value E(x) of the energy is set to a maximum value.

Next, the information processing apparatus 10 performs calculation of W_{j1,j2} (step S302). Here, on the assumption that the coupling coefficient W is a symmetric matrix, the values of the elements of the coupling coefficient W are 0 for j₁=j₂, and only the upper triangular portion of the matrix is used, j₂ and j₁ are exchanged when j₂>j₁.

Next, the information processing apparatus 10 calculates expression (4) below to calculate W_{j1,j2} (step S303).

$${W}_{{j}_{1} , {j}_{2}} = {\sum }_{k = 1}^{K} {U}_{j 1 , k} {V}_{k , j 2} \qquad ( 4 )$$

When there is an error value, the information processing apparatus 10 adds the error value to W_{j1,j2} (step S304). In steps S303 and S304, the coupling coefficient W is calculated at corresponding positions. Here, an error eᵢⱼ is a Wᵢⱼ−(UV)ᵢⱼ and stored in the memory as (i, j, eᵢⱼ) or the like together with the positional information of the element. In so doing, not all the errors are stored, but, for example, several errors are selected in descending order. Steps S301 to S304 correspond to step S104 of the minimum solution searching process illustrated in FIG. 6.

After setting x₀=x, the information processing apparatus 10 randomly inverts the bits of x (step S305). Here, the current state x is stored as x₀, and the bits of x are flipped.

Next, the information processing apparatus 10 calculates expression (5) below to calculate E(x) (step S306). The energy Eⱼ₁ⱼ₂ in the energy calculation unit 204 is calculated. The calculation in step S306 may be collectively performed for some sets of j₁, j₂. Steps S305 and S306 correspond to step S105 of the minimum solution searching process illustrated in FIG. 6.

$$E ( x ) = {\sum }_{{j}_{1} , {j}_{2} , i = 1}^{C} {W}_{{j}_{1} , {j}_{2}} {x}_{i , {j}_{1}} {x}_{( i + 1 ) , {j}_{2}} \qquad ( 5 )$$

Next, the information processing apparatus 10 adds together the entire energy of the energy calculation unit 204 to be stored in the memory 505 to obtain Ecand(x) (step S307). Step S307 corresponds to step S106 of the minimum solution searching process illustrated in FIG. 6.

Next, the information processing apparatus 10 uses E(x), Ecand(x), and the temperature T to determine whether to accept or reject based on the Metropolis criterion (step S308). In the acceptance determination, a minimum value Emin(x) of E(x) and its xmin are stored. Step S308 corresponds to step S107 of the minimum solution searching process illustrated in FIG. 6.

Next, when accepted, the information processing apparatus 10 performs updating so as to set E=Ecand(x) and x₀=x, returns to step S305, and repeats the processing a predetermined number of times (step S309). This loop is repeated a predetermined number of times or until Emin(x) reaches a certain value. Then, Emin(x) and xmin are output, and the minimum solution searching process illustrated in FIG. 10 ends. Step S309 corresponds to steps S108 and S109 of the minimum solution searching process illustrated in FIG. 6.

In the minimum solution searching process described above by using the traveling salesman problem as the example, the calculation is performed by using x as it is instead of using the difference. However, the calculation may also be similarly performed with the difference Δx of x. When the error for each element of the matrix is separately transmitted, the set of (the row number, the column number, and the error value) are transferred to the memory and restored while performing the reference by using the coupling coefficient W restoration unit 211. Regarding the errors, the errors are only added to the elements of W′=U*V restored by using U and V. Thus, the restoration may be easily performed.

The matrix decomposition technique is not limited to the singular value decomposition and may be any decomposition technique as long as decomposition is successfully performed. For example, nonnegative matrix factorization in which a matrix after decomposition is limited to nonnegative values or 01 matrix factorization in which a matrix after decomposition is limited to be binary. The selection of the matrix decomposition technique depends on how the coupling coefficient W of the problem to be solved is desired to be handled.

The example of the minimum solution searching process described above indicates the case where the coupling coefficient W is of the second degree. However, even in the case where the coupling coefficient W is of the third- or higher-degree, similar processing may be performed by using, for example, tensor decomposition or the like. One of examples of tensor decomposition is Tucker decomposition. This decomposes the three-dimensional array Z into A, B, C, D. Z is an array of N*N*N, each of A, B, and C is an array of N*k, D is an array of k*k*k, and Z_{abc}=ΣᵢΣⱼΣₖDᵢⱼₖAᵢₐB_{ib}C_{ic}. This may also be calculated by the product-sum operation, and compression may be performed by similar calculation as in the case where the coupling coefficient W is of the second degree.

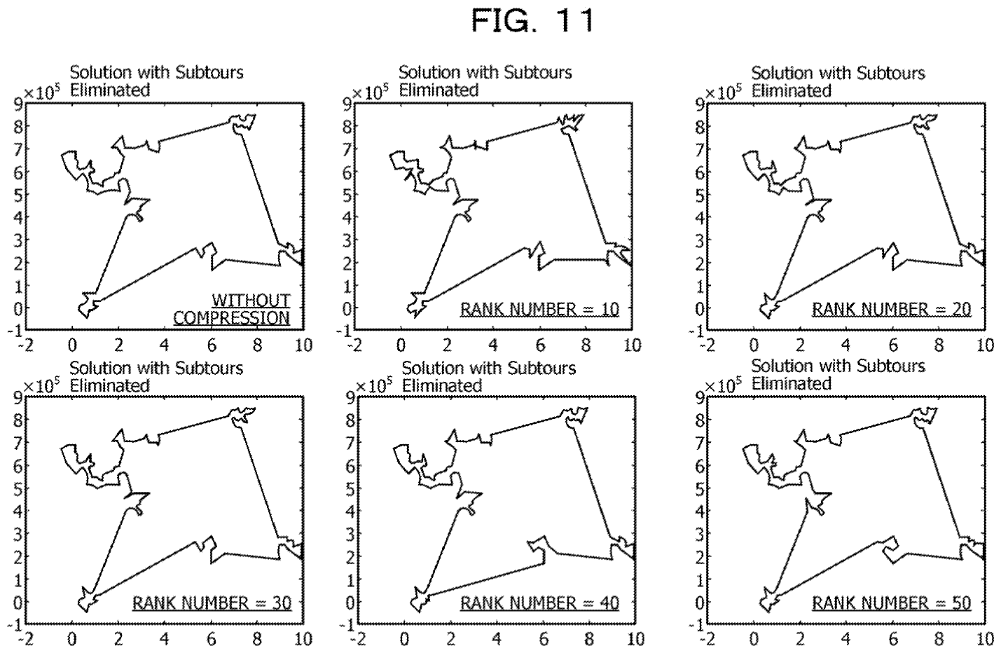

The minimum solution searching process according to the present embodiment has been described by using the traveling salesman problem. Examples of the results of the process is described. FIG. 11 illustrates the examples of the results of the minimum solution searching process according to the present embodiment. FIG. 11 illustrates visiting routes for cities to visit as results of execution of the minimum solution searching process according to the present embodiment made by compressing benchmark data (150 cities) of the traveling salesman problem by using a predetermined rank number k.

The processing results illustrated in FIG. 11 are results of processing the rank number=0 (without compression) to 50 in increments of 10 from the upper left. The processing result without compression at the upper left is a result obtained by processing the coupling coefficient W as it is, and this is correct answer data. When the processing result without compression and the processing result with the rank number=10 are compared, it may be understood that, although the general shapes of the visiting routes coincide with each other, there are differences in detailed parts. In contrast, it may be understood that, with the processing result with the rank number=40 or 50, the differences from the processing result without compression almost disappear. The extent to which the differences are allowed is determined by setting an allowable error by the user depending on data to be handled, and the minimum rank number k within the allowable error is searched.

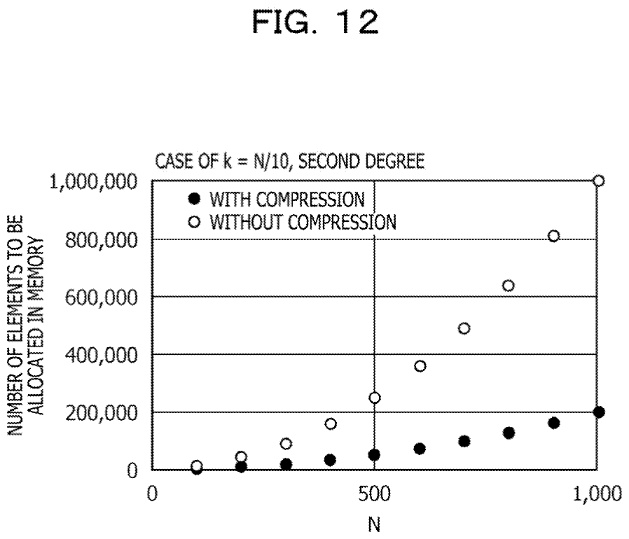

With reference to FIG. 12, an example of the difference in memory allocation amount depending on whether the compression is performed according to the present embodiment. FIG. 12 illustrates the example of the difference in memory allocation amount depending on whether the compression is performed according to the present embodiment. When the coupling coefficient W is not compressed, in the case where the coupling coefficient W of the number of bits N is the second degree, N² coefficients are to be allocated in the memory, and in the case where the coupling coefficient W is the Dth degree, N^{D} coefficients are to be allocated in the memory. According to the present embodiment, when the rank number is k, the number of the coefficients may be decreased to (2N+1)k in the case of the second degree and (k³+3 kN) in the case of the third degree. The compression ratio is (2N+1)k/N² to 2k/N in the case of the second degree and (k³+3 kN)/N³) in the case of the third degree.

A graph illustrated in FIG. 12 indicates the relationship between N and the number of elements to be allocated in the memory when the coupling coefficient W is the second degree and k=N/10. The graph illustrated in FIG. 12 is an example in which the case where the compression according to the present embodiment is performed on the coupling coefficient W is compared with the case where the compression is not performed. Referring to FIG. 12, it may be understood that, even when N is increased, the number of elements to be allocated in the memory is suppressed to be smaller in the case with the compression than in the case without the compression.

### Effects

As described above, the information processing apparatus 10 decomposes the matrix of the coupling coefficient representing interaction between a plurality of variables into a plurality of matrices by using the rank number, obtains, from the plurality of matrices, a second element corresponding to a first element of the coupling coefficient, and restores the first element based on the second element.

In solving a discrete optimization problem, the information processing apparatus 10 allocates in the memory only the compressed elements instead of allocating in the memory the matrix including all the coupling coefficients. Accordingly, the size of data to be allocated in the memory may be suppressed.

A process of decomposing into the plurality of matrices executed by the information processing apparatus 10 includes a process of decomposing the coupling coefficient into the plurality of matrices for each rank number by using the plurality of rank numbers. The information processing apparatus 10 further calculates an error between the matrix restored based on the plurality of matrices and the matrix of the coupling coefficient and determines a first rank number that is an allowable error from the plurality of rank numbers based on the error. The process of obtaining the second element executed by the information processing apparatus 10 includes a process of obtaining the second element from a plurality of matrices decomposed by using the first rank number.

Accordingly, the information processing apparatus 10 may suppress the size of data to be allocated in the memory while suppressing, to an allowable range, the distortion generated when the coupling coefficient is decomposed and restored.

The process of decomposing into the plurality of matrices executed by the information processing apparatus 10 includes a process of decomposing the matrix of the coupling coefficient which is a second-degree matrix into the plurality of matrices by using at least one of singular value decomposition, nonnegative matrix factorization, and 0/1 matrix decomposition.

Accordingly, the information processing apparatus 10 may select and use a more appropriate matrix decomposition technique depending on how the coupling coefficient W of the problem desired to be solved is desired to be handled.

The process of decomposing into the plurality of matrices executed by the information processing apparatus 10 includes a process of decomposing the matrix of the coupling coefficient which is a third- or higher-degree matrix into the plurality of matrices by using tensor decomposition.

Accordingly, the information processing apparatus 10 may suppress the size of data to be allocated in the memory not only in the case where the coupling coefficient is of the second degree but also in the case where the coupling coefficient is of a third or higher degree.

The process of obtaining the second element executed by the information processing apparatus 10 includes a process of obtaining the second element corresponding to the first element in a region of an upper triangular matrix or a lower triangular matrix of the matrix of the coupling coefficient which is a symmetric matrix. The process of restoring the first element includes a process of restoring first elements in regions of the upper triangular matrix and the lower triangular matrix based on the second element.

Thus, the information processing apparatus 10 may further suppress the size of data to be allocated in the memory.

[System]

Unless otherwise specified, processing procedures, control procedures, specific names, and information including various types of data and parameters described in the above-described document or drawings may be arbitrarily changed. The specific examples, distributions, numerical values, and so forth described in the examples are merely exemplary and may be arbitrarily changed.

Each element of each illustrated apparatus is of a functional concept and is not necessarily physically configured as illustrated in the drawings. For example, the specific form of distribution or integration of each apparatus is not limited to that illustrated in the drawings. For example, the entirety or part of the apparatus may be configured so as to be functionally or physically distributed or integrated in any units in accordance with various types of loads, usage states, or the like. All or any part of the processing functions performed by each apparatus may be realized by a CPU and a program analyzed and executed by the CPU or may be realized by hardware using wired logic.

[Hardware]

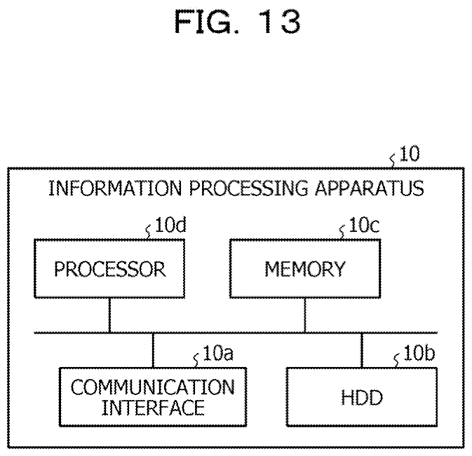

FIG. 13 explains a hardware configuration example. As illustrated in FIG. 13, the information processing apparatus 10 includes a communication interface 10a, an HDD 10b, a memory 10c, and a processor 10d. The components illustrated in FIG. 13 are coupled to each other by a bus or the like.

The communication interface 10a is a network interface card or the like and performs communication with other servers. The HDD 10b stores a database (DB) and a program for operating the functions illustrated in FIG. 3.

The processor 10d is a hardware circuit that reads, from the HDD 10b or the like, the program for executing processes similar to those of the processing units illustrated in FIG. 3 and loads the program to the memory 10c to operate processes of executing the functions illustrated in FIG. 3 or the like. For example, these processes execute the functions similar to the functions of the processing units included in the information processing apparatus 10.

The information processing apparatus 10 operates as an information processing apparatus that executes an operation control process by reading and executing the program for executing the processes similar to those of the processing units illustrated in FIG. 3. The information processing apparatus 10 may also realize functions similar to the functions of the above-described examples by reading the program from a recording medium with a medium reading device and executing the read program. Execution of this program is not limited to the execution by using the information processing apparatus 10. For example, the present embodiment may be similarly applied when another computer or a server executes the program or the other computer and the server cooperate with each other to execute the program.

The program for executing the processes similar to those of the processing units illustrated in FIG. 3 may be distributed through a network such as the Internet. The program may be recorded on a computer-readable recording medium such as a hard disk, a flexible disk (FD), a compact disc read-only memory (CD-ROM), a magneto-optical disk (MO), or a Digital Versatile Disc (DVD) and may be executed by being read from the recording medium by the computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
one or more memories; and
one or more processors coupled to the one or more memories and the one or more processors configured to:
decompose a first matrix of a coupling coefficient which represents interaction between a plurality of variables into a plurality of matrices by using a rank number,
obtain, from the plurality of matrices, a second element that corresponds to a first element of the coupling coefficient, and
restore the first element based on the second element.

2. The information processing apparatus according to claim 1, wherein the one or more processors is further configured to:
decompose the coupling coefficient into the plurality of matrices by using a plurality of rank numbers,
restore a second matrix based on the plurality of matrices,
calculate an error between the second matrix and the matrix of the coupling coefficient,
determine a first rank number which is an allowable error from the plurality of rank numbers based on the error, and
obtain the second element from the plurality of matrices decomposed by using the first rank number.

3. The information processing apparatus according to claim 1, wherein the one or more processors is further configured to decompose the first matrix which is a second-degree matrix into the plurality of matrices by using at least one selected from singular value decomposition, nonnegative matrix factorization, and 0/1 matrix decomposition.

4. The information processing apparatus according to claim 1, wherein the one or more processors is further configured to decompose the first matrix which is a third-degree or higher-degree matrix into the plurality of matrices by using tensor decomposition.

5. The information processing apparatus according to claim 1, wherein the one or more processors is further configured to:
obtain the second element which corresponds to the first element in a region of a triangular matrix selected from an upper triangular matrix of the first matrix and a lower triangular matrix of the first matrix which is a symmetric matrix, and
restore first elements in regions of the upper triangular matrix and the lower triangular matrix based on the second element.

6. An information processing method for a computer to execute a process comprising:
decomposing a first matrix of a coupling coefficient which represents interaction between a plurality of variables into a plurality of matrices by using a rank number;
obtaining, from the plurality of matrices, a second element that corresponds to a first element of the coupling coefficient; and
restoring the first element based on the second element.

7. The information processing method according to claim 6,
wherein the decomposing includes decomposing the coupling coefficient into the plurality of matrices by using a plurality of rank numbers,
wherein the process further comprising:
restoring a second matrix based on the plurality of matrices,
calculating an error between the second matrix and the matrix of the coupling coefficient, and
determining a first rank number which is an allowable error from the plurality of rank numbers based on the error,
wherein the obtaining includes obtaining the second element from the plurality of matrices decomposed by using the first rank number.

8. The information processing method according to claim 6, wherein
the decomposing includes decomposing the first matrix which is a second-degree matrix into the plurality of matrices by using at least one selected from singular value decomposition, nonnegative matrix factorization, and 0/1 matrix decomposition.

9. The information processing method according to claim 6, wherein
the decomposing includes decomposing the first matrix which is a third-degree or higher-degree matrix into the plurality of matrices by using tensor decomposition.

10. The information processing method according to claim 6, wherein
the obtaining includes obtaining the second element which corresponds to the first element in a region of a triangular matrix selected from an upper triangular matrix of the first matrix and a lower triangular matrix of the first matrix which is a symmetric matrix, and
the restoring includes restoring first elements in regions of the upper triangular matrix and the lower triangular matrix based on the second element.

11. A non-transitory computer-readable storage medium storing an information processing program that causes at least one computer to execute a process, the process comprising:
decomposing a first matrix of a coupling coefficient which represents interaction between a plurality of variables into a plurality of matrices by using a rank number;
obtaining, from the plurality of matrices, a second element that corresponds to a first element of the coupling coefficient; and
restoring the first element based on the second element.

12. The non-transitory computer-readable storage medium according to claim 11,
wherein the decomposing includes decomposing the coupling coefficient into the plurality of matrices by using a plurality of rank numbers,
wherein the process further comprising:
restoring a second matrix based on the plurality of matrices;
calculating an error between the second matrix and the matrix of the coupling coefficient; and
determining a first rank number which is an allowable error from the plurality of rank numbers based on the error,
wherein the obtaining includes obtaining the second element from the plurality of matrices decomposed by using the first rank number.

13. The non-transitory computer-readable storage medium according to claim 11, wherein
the decomposing includes decomposing the first matrix which is a second-degree matrix into the plurality of matrices by using at least one selected from singular value decomposition, nonnegative matrix factorization, and 0/1 matrix decomposition.

14. The non-transitory computer-readable storage medium according to claim 11, wherein
the decomposing includes decomposing the first matrix which is a third-degree or higher-degree matrix into the plurality of matrices by using tensor decomposition.

15. The non-transitory computer-readable storage medium according to claim 11, wherein
the obtaining includes obtaining the second element which corresponds to the first element in a region of a triangular matrix selected from an upper triangular matrix of the first matrix and a lower triangular matrix of the first matrix which is a symmetric matrix, and
the restoring includes restoring first elements in regions of the upper triangular matrix and the lower triangular matrix based on the second element.
